(19) United States
(12) Patent Application Publication
(10) Pub. No.: US 2013/0089852 A1
(43) Pub. Date: Apr. 11, 2013

(54) Methods of Teaching and Learning Using Movement

(71) Applicant: Suzanne D. Kuntz, Ithaca, NY (US)

(72) Inventor: Suzanne D. Kuntz, Ithaca, NY (US)

(21) Appl. No.: 13/700,857

(22) PCT Filed: Jun. 2, 2011
(86) PCT No.: PCT/US11/38861

§ 371 Date: Nov. 29, 2012

Related U.S. Application Data
(60) Provisional application No. 61/350,499, filed on Jun. 2, 2010.

(51) Int. Cl. G09B 1/00

(52) U.S. Cl. CPC G09B 1/00
USPC 434/430

(57) ABSTRACT

Methods of teaching and learning use a multi-sensory approach where students physically move as they practice and learn the relationships of words, numbers, or any abstract concept. In some embodiments, methods include physical activity and imagination when practicing. In some embodiments, activity mats allow students to physically move as they learn the relationships of abstract concepts thus using more learning modalities (visual, auditory, motor, and kinesthetic) when practicing. Methods result in enthusiasm for the task of learning and practicing the abstract concept. Enthusiasm for the task leads to greater willingness to practice over and over again, thus leading to competence in learning, often at a younger age than conventionally expected. In some embodiments, the instructions are provided to the student by an automated device. In some embodiments, a GPS device provides the student with instructions associated with a specific display that the student has found.

### REFERENCE TO RELATED APPLICATIONS

This application claims one or more inventions which were disclosed in Provisional Application No. 61/350,499, filed Jun. 2, 2010, entitled “Teaching Abstract Concepts Through Movement”. The benefit under 35 USC §119(e) of the United States provisional application is hereby claimed, and the aforementioned application is hereby incorporated herein by reference.

### BACKGROUND OF THE INVENTION

### Field of the Invention

The invention pertains to the field of teaching methods. More particularly, the invention pertains to methods of teaching using movement.

### SUMMARY OF THE INVENTION

Methods of teaching and learning use a multi-sensory approach where students physically move as they practice and learn the relationships of words, numbers, or any abstract concept. In some embodiments, methods include physical activity and imagination when practicing. In some embodiments, activity mats allow students to physically move as they learn the relationships of abstract concepts thus using more learning modalities (visual, auditory, motor, and kinesthetic) when practicing. Methods result in enthusiasm for the task of learning and practicing the abstract concept. Enthusiasm for the task leads to greater willingness to practice over and over again, thus leading to competence in learning, often at a younger age than conventionally expected. In some embodiments, the instructions are provided to the student by an automated device. In some embodiments, a GPS device provides the student with instructions associated with a specific display that the student has found.

### BRIEF DESCRIPTION OF THE DRAWINGS

FIG. 1 shows a skip counting by nines display in an embodiment of the present invention.

FIG. 2 shows a number line display in an embodiment of the present invention.

FIG. 3 shows a skip counting chart in an embodiment of the present invention.

FIG. 4 shows a Cartesian coordinate hop display in an embodiment of the present invention.

FIG. 5 shows a place value hop display in an embodiment of the present invention.

FIG. 6 shows an add/subtract display in an embodiment of the present invention.

FIG. 7 shows a clock hop display in an embodiment of the present invention.

FIG. 8 shows a fraction walk display in an embodiment of the present invention.

FIG. 9 shows a positive and negative number hop display in an embodiment of the present invention.

FIG. 10 shows a blending display in an embodiment of the present invention.

FIG. 11 shows a sentence hop display in an embodiment of the present invention.

FIG. 12 shows a contraction hop display in an embodiment of the present invention.

FIG. 13 shows an animal name hop display in an embodiment of the present invention.

FIG. 14 shows a word hop display in an embodiment of the present invention.

FIG. 15 shows a foreign language display in an embodiment of the present invention.

FIG. 16 shows a make-a-word hop display in an embodiment of the present invention.

### DETAILED DESCRIPTION OF THE INVENTION

Methods of teaching and learning include movement in combination with one or more of visual or verbal reinforcement of the concept. The subject area may be in the field of mathematics, the field of linguistics, or any other field of learning, including, but not limited to, science and history. In some embodiments, the method includes chanting the associated concept as the student hops, walks, crawls, dances on or touches the concept that is imprinted on the floor or wall. In some embodiments, the concept that is imprinted on the floor or wall is used as a tool to figure out the solution to questions or problems. In some embodiment the abstract concept that is imprinted on the floor or wall is used to engage a student in activities including, but not limited to, matching exercises where a student lays a matching item on the floor next to the display, where the matching item can be in the form of a card or an item, pen and paper matching exercises, and games.

In some embodiments, methods of teaching combine cadence repetition of a concept with synchronized vigorous physical motion on a layout of the numbers, words, or concept being recited. In some embodiments, a floor mat, rug, other display, or wall banner, on which the concepts are imprinted, is used in such a way that the student moves from one concept to another while reciting the corresponding number, letter, word, or other element. In some embodiments, a display is used as a tool to learn or determine the answer questions about concepts. In some embodiments, associated activities, exercises, and games are used for learning abstract concepts.

A display, as used herein, may be any display of indicia related to the learning or teaching of one or more concept and

a) provided permanently at a particular location on a floor or ground surface, including, but not limited to a display on any flooring medium, including, but not limited to, floor tiling, wood flooring, vinyl flooring, cork, rubber flooring, concrete, a sidewalk, or a blacktop, with the indicia being displayed using any permanent medium, including, but not limited to, an oil-based paint, a latex paint, or a polymeric medium, or

b) provided movably on a floor or ground surface, including, but not limited to, on a floor mat, on a rug, or as a projection onto the floor or ground.

The images on the display preferably divide the display into different areas, which may be any shape, including, but not limited to, circular, triangular, rectangular, or square. The display is preferably sized such that the different areas are spaced about the distance of the stride of a student apart. In some embodiments, the areas are of at least about the dimension of the length of a foot or shoe of the student. In other embodiments, the areas are no farther apart than the distance of an average standing hop of the student from the center of one area to the center of a neighboring area on the display.

Indicia, as used herein, may be any markings relating to the concept being taught using methods and the display, including, but not limited to, numerals, letters, words, images, and any combination of numerals, letters, words, and images.

A mathematical concept, as used herein, may be any mathematical concept, including, but not limited to, place value, multiples including skip counting, Cartesian coordinates, proper fractions, improper fractions, mixed numbers, manipulation of fractions, positive and negative numbers, unit circle, geometry, multiplication, division, addition, subtraction, factoring, measurement, rounding, estimation, clock, money, number patterns, decimals, percents, number recognition, understanding of the value of numbers, one-to-one correspondence, odd and even numbers, trigonometry, calculus, probability, and statistics.

A linguistic concept, as used herein, may be any linguistic concept, including, but not limited to, sound and word recognition, sight words, color words, blending words, contractions, phonetic blending of short vowel words, transfer between spoken words and sentences to reading, and words and alphabets from foreign languages.

Other concepts, which may be taught and learned using methods of the present invention, include, but are not limited to, scientific terms, animal names, historical timelines, social studies terms, musical notes, the relationships of musical notes, and any other concept that is appropriate for a flash card.

In a preferred embodiment, all of the following elements are present: physical exercise, chanting or saying the abstract concept synchronized with that exercise, a properly laid out display, and activities.

Methods of the present invention are preferably accomplished using displays of one or more floor mats or wall banners such as those shown in the drawings. To illustrate some principles of the methods, methods of teaching and learning are described below for specific concepts using the displays shown in the drawings.

### Hopping the Multiples

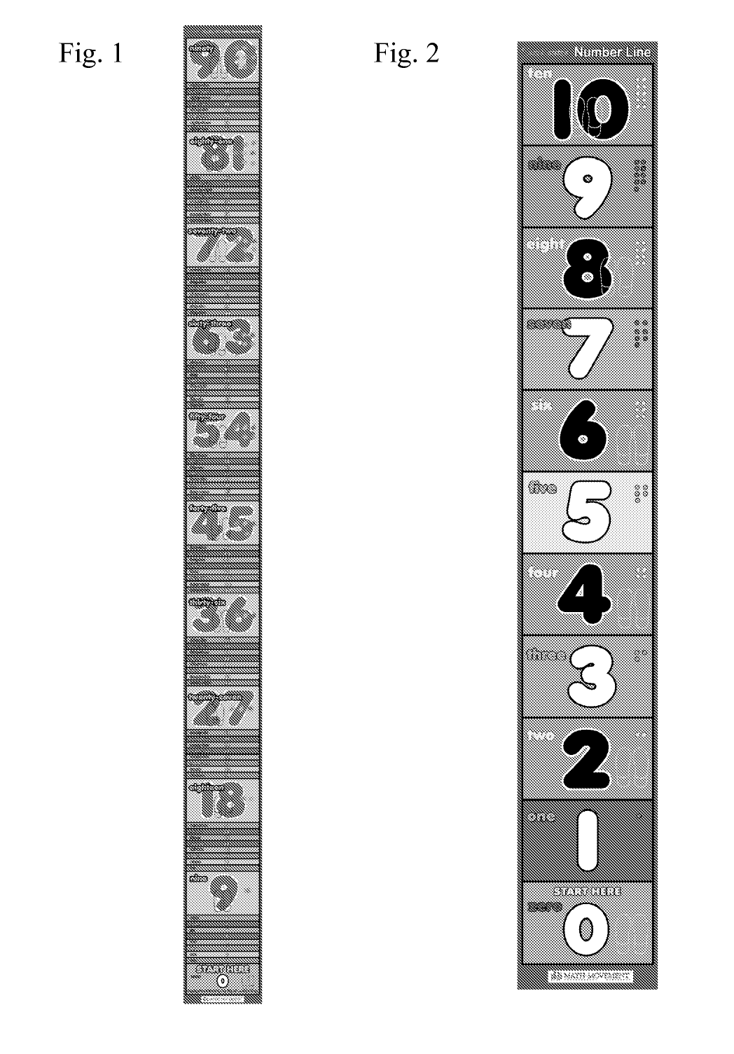

A number line hopping display helps children learn skip counting (i.e., the multiples), multiplication, division, factoring, number recognition, the value of numbers, one-to-one correspondence, odd and even numbers, addition, and subtraction, while engaging the student in rigorous physical exercise. FIG. 1 shows a hopping display for the multiples of nine, but a number line hopping display may be for the multiples of any number.

The hopping display of FIG. 1 has the general form in which numbers are arranged in patterns corresponding to what can be called “skip counting,” which are in fact tables of successive multiples of one, two, three, four, and so on.

In a teaching situation, the child is asked to jump or skip from place to place while chanting the corresponding multiple or multiplication fact. In the form of a floor mat, the hopping display is portable and lends itself to use indoors as well as out of doors, and to use with many children at once, each on their own mat. Each child engages in rigorous physical exercise when hopping or jumping on the displays.

In one method, the child is instructed to hop, walk, or jump only on numbers that are multiples while chanting the number simultaneously. Children can figure out multiplication by studying the pattern of symbols on the display. In one method, the child skip counts on her fingers, and when asked “what is 4 times 9?”, the student holds up four fingers and counts by nines by touching or squeezing the top of each of the 4 fingers, or vice versa. In one method, the child hops on each multiple while saying the corresponding multiplication fact or locating the answer to “9 times 3?”

### Number Line Counting

In one method, a child takes a number walk on the giant number line of FIG. 2. The child may be instructed to step on each number while simultaneously saying the number name. If the counting and stepping on the number are out of sync, she is encouraged to go back and start on the zero. Other activities include, but are not limited to, walking backwards from 10 to 1, learning odd and even numbers, playing games while practicing and learning the value of numbers, adding and subtracting the numbers, and engaging in movement-based exercises that help the child to stay engaged in the process of learning and practicing. These activities demonstrate the ability of these methods to make learning math patterns and numbers accessible to preschool children.

### Active Math Whisper/Loud Counting

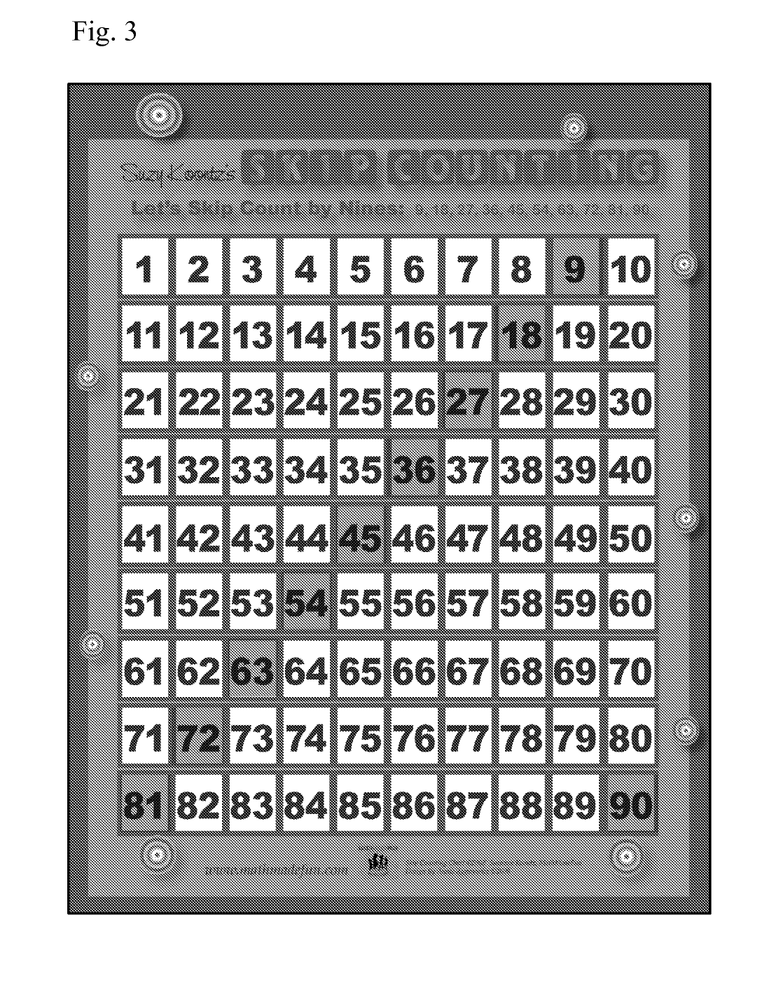

In some embodiments, the method includes counting where one whispers numbers that are not multiples and counts in a louder voice the numbers that are multiples of a number. If the multiples are unknown, then a wall chart or floor chart such as the one shown in FIG. 3 offers visual support. In addition, the method preferably includes simultaneous involvement with physical exercise. In one embodiment to practice skip counting by threes, the method comprises the following steps: The student lifts his left leg, touches his left foot with his right hand, and whispers “one”. The student then lifts his right leg, touches his right foot with his left hand, and whispers “two”. The student then claps and says “three” in a louder voice. The student continues counting to a predetermined number (e.g., thirty) using this sequence of actions.

### Active Math Skip Counting

In some embodiments, the method includes chanting the multiples while engaging in physical exercise of any form. A visual aid such as the chart of FIG. 3 in the form of a skip counting wall banner allows students who have not learned the multiples to join the chanting. The method calls for frequent chanting of the multiples while simultaneously engaging in physical exercise. The method encourages chanting during transition times throughout the school day, such as in the hallway and in between activities, while engaging in cross-body exercises. The method may also be used during warm-up calisthenics for any sport or physical activity.

### Cartesian Coordinates

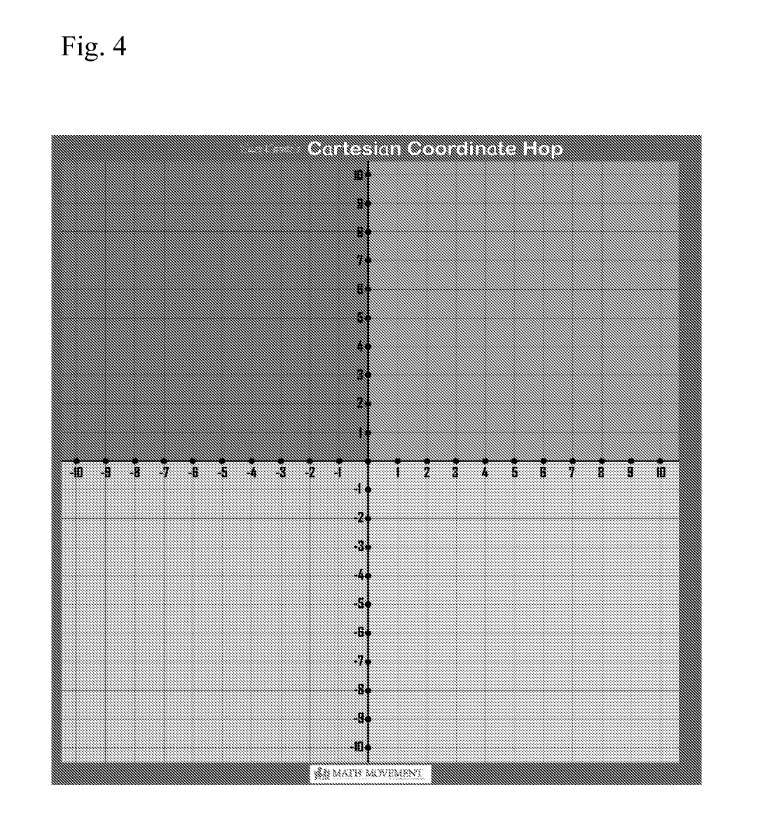

The Cartesian coordinate chart of FIG. 4 may be used to teach children how to find points in Cartesian coordinates. In one embodiment, the child is given a card with Cartesian coordinates and the child physically walks on the Cartesian coordinate display to find the specific Cartesian coordinates given on the card. In one embodiment, the child puts an object somewhere on the display, walks on the display to determine the location of the object in terms of Cartesian coordinates, marks the coordinates on a card, and then puts card beneath the object on the display.

Displaying the Cartesian coordinates grid on the floor in a visible form, including, but not limited to, on a mat, on tiling, and using a stencil and a permanent medium such as a paint, and having students walk on it offers a kinesthetic opportunity for students to practice one or more concept, including, but not limited to, locating points on a Cartesian coordinate grid, one-to-one correspondence, slope, shapes, transformations, equations of lines, addition, and subtraction.

### Place Value Hop

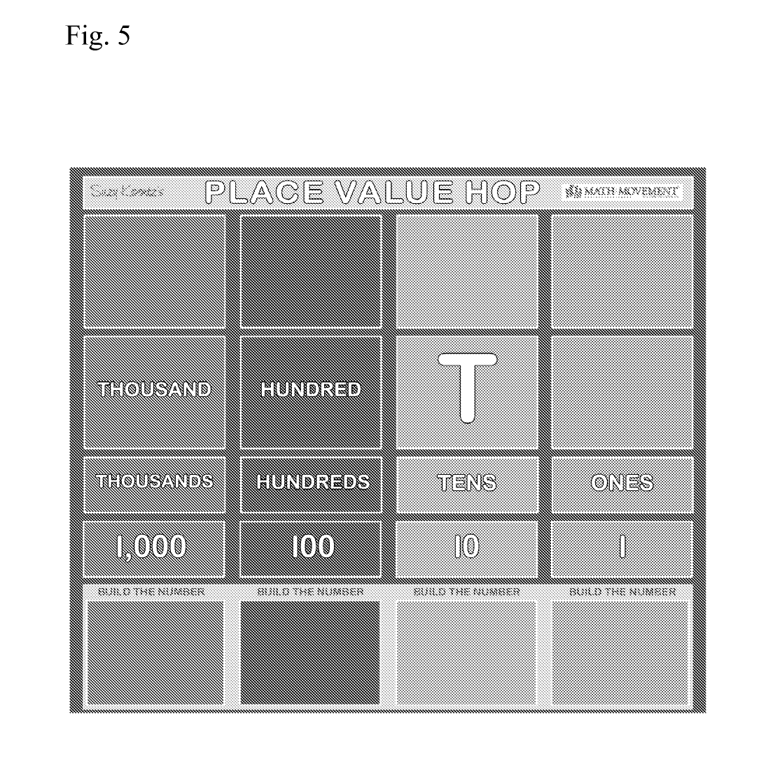

The chart of FIG. 5 may be used in methods of the present invention, which make learning the concept of place value accessible to young children. The chart of FIG. 5 may be used with numerals on cards to form integers up to 9,999. In other embodiments, a place value hop display may include decimals or allow students to learn place values up to the millions and beyond.

The method of imprinting place value in this format offers a kinesthetic opportunity for children to practice learning concepts, including, but not limited to, place value, one-to-one correspondence, odd and even numbers, addition, and subtraction.

In one embodiment, the chart of FIG. 5 is used in combination with numeral cards to create the numeral 7,269. The student puts a numeral card with the numeral 9 in the box at the top of the display above the “ones”, a numeral card with the numeral 6 in the box at the top of the display above the “tens”, a numeral card with the numeral 2 in the box at the top of the display above the “hundreds”, and a numeral card with the numeral 7 in the box at the top of the display above the “thousands”.

In one embodiment, the student is instructed to hop the number. The student hops on the numeral 7 card while saying “seven”, then hops on the “thousand” rectangle while saying “thousand”, then hops on the numeral 1 card while saying “one”, then hops on the “hundred” rectangle while saying “hundred”, then hops on the numeral 6 card while saying “six”, then hops on the “T” rectangle while saying “t”, and finally hops on the numeral 9 card while saying “nine”.

In another embodiment, the student learns another mathematical concept, including, but not limited to, how to add or subtract ones, tens, hundreds, thousands, or ten thousands by adding or subtracting blocks and readjusting the number cards.

In another embodiment, the student creates the number 7,169.4 on a display with at least one column for decimals. First, the student forms the non-decimal part of the number as in the previous embodiment. Then the student puts an “AND” card in the ones place below the “9” card and next to the “T” rectangle, a numeral card with the numeral 4 in the box at the top of the display above the “tenths”, and a “tenths” card in the tenths box below the numeral 4 card. The student hops the non-decimal part of the number as in the previous embodiment. The student then hops on the “AND” while saying “and”, hops on the numeral 4 card while saying “four,” and hops on the tenths card while saying “tenths”.

In another embodiment, the student creates the number 7,169.48 on a display with at least two columns for decimals. First, the student forms the non-decimal part of the number as in the previous embodiment. Then the student puts an “AND” card in the ones place below the “9” card and next to the “T” rectangle, a numeral card with the numeral 4 in the box at the top of the display above the “tenths”, a “T” card in the tenths box below the numeral 4 card, a numeral card with the numeral 8 in the box at the top of the display above the “hundredths”, and a “hundredths” card in the hundredths box below the numeral 8 card. The student hops the non-decimal part of the number as in the previous embodiment. The student then hops on the “AND” while saying “and”, hops on the numeral 4 card while saying “four”, hops on the “T” card while saying “t”, hops on the numeral 8 card while saying “eight”, and hops on the “hundredths” card while staying “hundredths”.

In another embodiment, the student creates the number 7,169.485 on a display with at least three columns for decimals. First, the student forms the non-decimal part of the number as in the previous embodiment. Then the student puts an “AND” card in the ones place below the “9” card and next to the “T” rectangle, a numeral card with the numeral 4 in the box at the top of the display above the “tenths”, a “hundred” card in the tenths box below the numeral 4 card, a numeral card with the numeral 8 in the box at the top of the display above the “hundredths”, a “T” card in the hundredths box below the numeral 8 card, a numeral card with the numeral 5 in the box at the top of the display above the “thousandth”, and a “thousandths” card in the thousandths box below the numeral 5 card. The student hops the non-decimal part of the number as in the previous embodiment. The student then hops on the “AND” while saying “and”, hops on the numeral 4 card while saying “four”, hops on the “hundred” card while saying “hundred”, hops on the numeral 8 card while saying “eight”, hops on the “T” card while staying “t”, hops on the numeral 5 card while saying “five”, and hops on the “thousandths” card while saying “thousandths”.

### Add/Subtract Grid

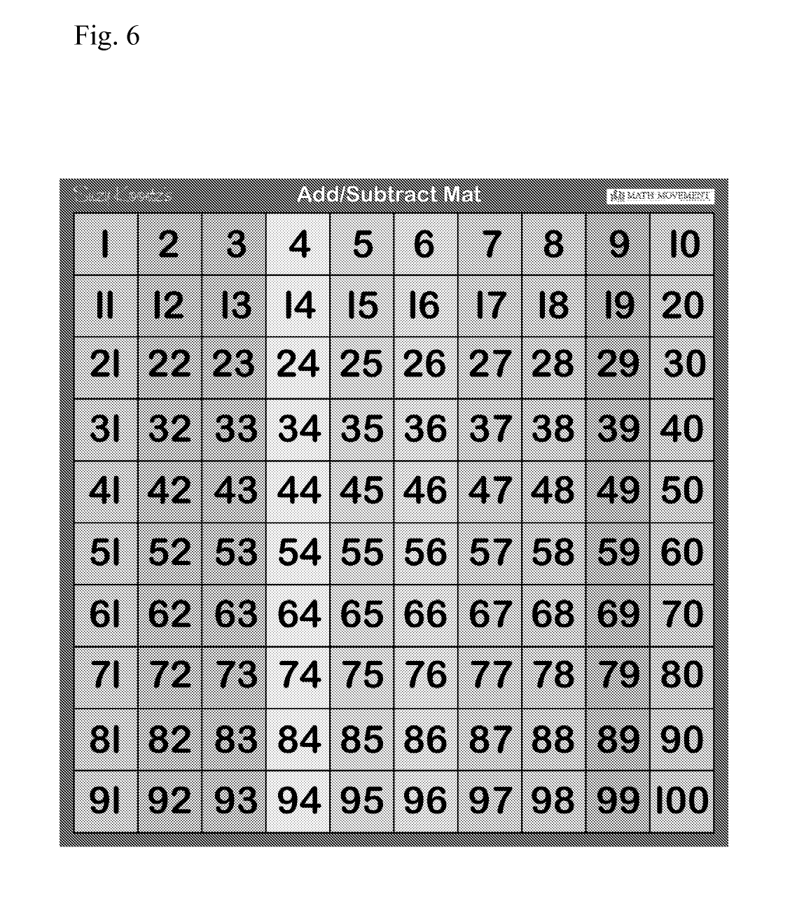

The grid of FIG. 6 may be used in activities including, but not limited to, adding or subtracting two-digit numbers, counting money, and other activities that build number sense.

In one embodiment, the student is instructed to add a two-digit number to another two-digit number. The student starts by finding and standing on the box corresponding to one of the two-digit numbers. The student then moves up the column of the grid a number of boxes corresponding to the tens digit of the second number and moves to the right on the grid a number of boxes corresponding to the ones digit of the second number. If the student reaches the far right box in the row before moving the right number of boxes, the student next moves to the far left box on the next row up the grid. The student ends up standing on the box representing the sum of the two numbers. The student may count out loud with each step in either direction, and the student may practice adding the tens and ones in either order. In one embodiment, the student adds the first number to the second number and then the second number to the first number to achieve the same answer.

In one embodiment, the student adds 34 to 43 by first standing on the 43 box. The student moves up the column of the grid, taking one step to the 53 box while saying “one” or “ten”, a second step to the 63 box while saying “two” or “twenty”, and a third step to the 73 box while saying “three” or “thirty”. The student then moves down the row, taking one step to the 74 box while saying “one” or “thirty-one”, a second step to the 75 box while saying “two” or “thirty-two”, a third step to the 76 box while saying “three” or thirty-three”, and a fourth step to the 77 box while saying “four” or “thirty-four”, thereby discovering that 77 is the sum of 34 and 43.

In one embodiment, the student is instructed to subtract a one-digit or two-digit number from a two-digit number. The student starts by finding and standing on the box corresponding to the larger number. The student then moves down the column of the grid a number of boxes corresponding to the tens digit of the smaller number and moves to the left on the grid a number of boxes corresponding to the ones digit of the smaller number. If the student reaches the far left box in the row before moving the right number of boxes, the student next moves to the far right box on the next row down the grid. The student ends up standing on the box representing the difference of the two numbers. The student may count out loud with each step in either direction, and the student may practice adding the tens and ones in either order.

### Clock Hop

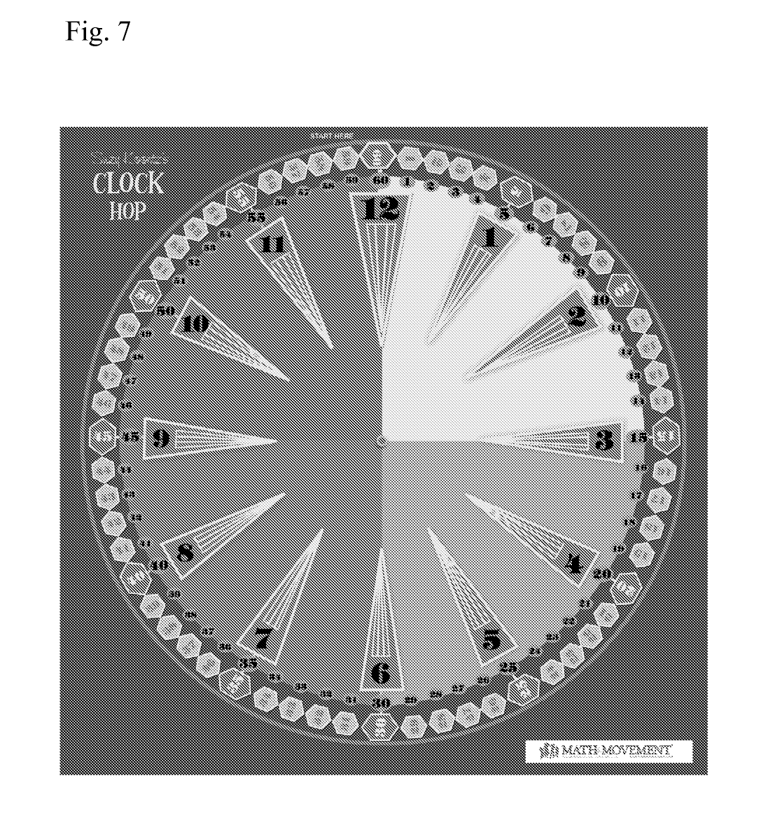

The display of FIG. 7 provides a kinesthetic opportunity for children to build number sense, to learn to tell time, and to skip count by fives. The large size of the display allows children to physically hop as they practice learning concepts, including, but not limited to, the relationships of the clock, thus providing the opportunity to use more learning modalities, including, but not limited to, visual, auditory, motor, and kinesthetic, when practicing.

In one embodiment, the child walks on the big numerals corresponding to the hours while counting the big numbers (1, 2, 3 . . . ) by starting at the “12” and stepping on each number while saying the number as she walks around the clock face.

In one embodiment, the child walks and counts by fives. The child starts at “START HERE” hexagon designated as “60” and skip counts by fives as he walks or hops on the multiples of five, which are differently colored in FIG. 7 than the non-multiples of five.

The quarters of the clock face in FIG. 7 are different colors, which allows children to appreciate the clock being split into quarters for learning both fractions and telling time. This design of the clock is preferably in the form of a stencil.

### Fraction Walk

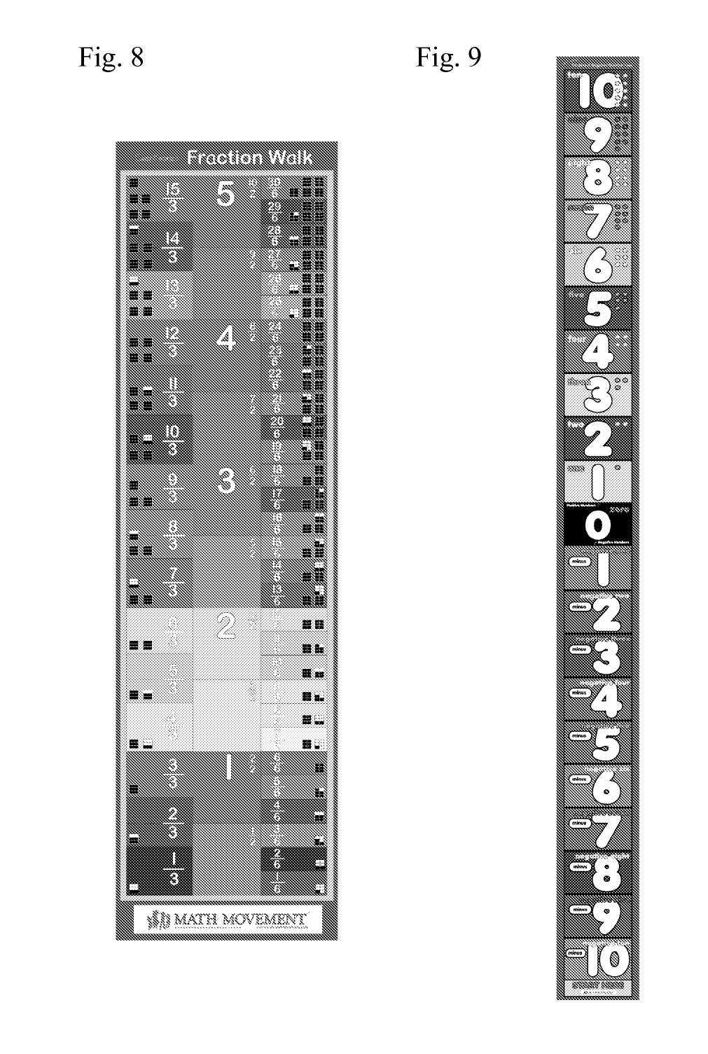

The display of FIG. 8 provides a kinesthetic opportunity for children to learn fractions. Children move as they practice learning concepts, including, but not limited to, the relationships of fractions and whole numbers, fraction recognition, and addition and subtraction of fractions. The display allows both adults and children to gain a visual image of fractions.

In one embodiment, the student is asked how many thirds are in a given whole number. If the whole number is four, the student steps on each third while counting her steps from one to twelve.

In one embodiment, the student is asked to determine how many whole numbers are in a given improper fraction. If the improper fraction is 8/3, the student steps on the whole numbers 1 and 2, and then looks to the left to see that there are two but not three whole numbers in 8/3.

In another embodiment, the student is asked to determine the mixed number equivalent to a given improper fraction. If the improper fraction is 8/3, the student steps on the whole numbers 1 and 2, and then looks to the left to see that there are not 3 whole numbers in 8/3. The student counts the thirds after the whole number 2 up to 8/3. The student counts “one-third”, “two-thirds” to see that the improper fraction 8/3 is the same as 2⅔. The student may also use the pictures that represent the whole and fraction parts of each number in the display of FIG. 8. The fraction 8/3 has two squares filled in with black and a third square with two of the three parts filled in with black.

### Positive and Negative Integers

The display of FIG. 9 provides a kinesthetic opportunity for students to learn concepts, including, but not limited to, positive and negative integers, one-to-one correspondence, odd and even numbers, addition and subtraction of positive and negative numbers, and skip counting by twos. In a movement-based method using the display of FIG. 9, the child is taught to add and subtract positive and negative numbers.

In one embodiment, the student is instructed to start on the first number while facing the positive end of the display and make one turn for each negative sign not including the first number in the equation. In this method, two negatives in the calculation require a 360 degree turn, thereby canceling the change in direction.

In one embodiment, the student is instructed to stand on the number line on the first number in the calculation while facing the positive end of the display. The student is asked to decide if any turns are necessary. The student is asked whether he is adding or subtracting. If subtracting, he makes a 180-degree turn. The student is then asked whether the second number is positive or negative. If the number is negative, he makes a 180-degree turn. The student then steps forward a block at a time preferably while counting aloud with each step up to the value of the second number.

In one embodiment, the student is asked to determine the answer to “3-5=”. The student starts by standing on the positive three (⁺3) block while facing the positive end of the display. The student is then asked or asks herself whether she is adding or subtracting. Since she is subtracting, she makes one turn and stands on the positive three (⁺3) block facing the negative end of the display. The student is then asked or asks herself what the sign of the second number is. Since the second number is positive, the student does not make another turn. The student walks five steps forward preferably while counting aloud from one to five to end up in the negative two (⁻2) block.

In another embodiment, the student is asked to determine the answer to “3−⁻5=”. The student starts by standing on the positive three (⁺3) block while facing the positive end of the display. The student is then asked or asks himself whether he is adding or subtracting. Since he is subtracting, he makes one turn and stands on the positive three (⁺3) block facing the negative end of the display. The student is then asked or asks himself what the sign of the second number is. Since the second number is negative, the student makes another turn and stands on the positive three (⁺3) block facing the positive end of the display. The student walks five steps forward preferably while counting aloud from one to five to end up in the positive 8 (⁺8) block.

In another embodiment, the student is asked to determine the answer to “3+⁺5=”. The student starts by standing on the positive three (⁺3) block while facing the positive end of the display. The student is then asked or asks herself whether she is adding or subtracting. Since she is adding, she does not turn and remains on the positive three (+3) block facing the positive end of the display. The student is then asked or asks herself what the sign of the second number is. Since the second number is positive, the student does not turn and remains on the positive three (⁺3) block facing the positive end of the display. The student walks five steps forward preferably while counting aloud from one to five to end up in the positive 8 (8) block.

In another embodiment, the student is asked to determine the answer to “3+⁻5=”. The student starts by standing on the positive three (⁺3) block while facing the positive end of the display. The student is then asked or asks himself whether he is adding or subtracting. Since he is adding, he does not turn and remains on the positive three (⁺3) block facing the positive end of the display. The student is then asked or asks himself what the sign of the second number is. Since the second number is negative, the student makes one turn and stands on the positive three (⁺3) block facing the negative end of the display. The student walks five steps forward preferably while counting aloud from one to five to end up in the negative two (⁻2) block.

In another embodiment, the student is asked to determine the answer to “⁻3−⁺5=”. The student starts by standing on the negative three (⁻3) block while facing the positive end of the display. The student is then asked or asks herself whether she is adding or subtracting. Since she is subtracting, she makes one turn and stands on the negative three (⁻3) block facing the negative end of the display. The student is then asked or asks herself what the sign of the second number is. Since the second number is positive, the student does not make another turn. The student walks five steps forward preferably while counting aloud from one to five to end up in the negative eight (⁻8) block.

In another embodiment, the student is asked to determine the answer to “⁻3−⁻5=”. The student starts by standing on the negative three (⁻3) block while facing the positive end of the display. The student is then asked or asks himself whether he is adding or subtracting. Since he is subtracting, he makes one turn and stands on the negative three (⁻3) block facing the negative end of the display. The student is then asked or asks himself what the sign of the second number is. Since the second number is negative, the student makes another turn and stands on the negative three (⁻3) block facing the positive end of the display. The student walks five steps forward preferably while counting aloud from one to five to end up in the positive two (⁺2) block.

In another embodiment, the student is asked to determine the answer to “⁻3+⁺5=”. The student starts by standing on the negative three (⁻3) block while facing the positive end of the display. The student is then asked or asks herself whether she is adding or subtracting. Since she is adding, she does not turn and remains on the negative three (⁻3) block facing the positive end of the display. The student is then asked or asks herself what the sign of the second number is. Since the second number is positive, the student does not turn and remains on the negative three (⁻3) block facing the positive end of the display. The student walks five steps forward preferably while counting aloud from one to five to end up in the positive two (⁺2) block.

In another embodiment, the student is asked to determine the answer to “⁻3+⁻5=”. The student starts by standing on the negative three (⁻3) block while facing the positive end of the display. The student is then asked or asks himself whether he is adding or subtracting. Since he is adding, he does not turn and remains on the negative three (⁻3) block facing the positive end of the display. The student is then asked or asks himself what the sign of the second number is. Since the second number is negative, the student makes one turn and stands on the negative three (⁻3) block facing the negative end of the display. The student walks five steps forward preferably while counting aloud from one to five to end up in the negative eight (⁻8) block.

### Blending

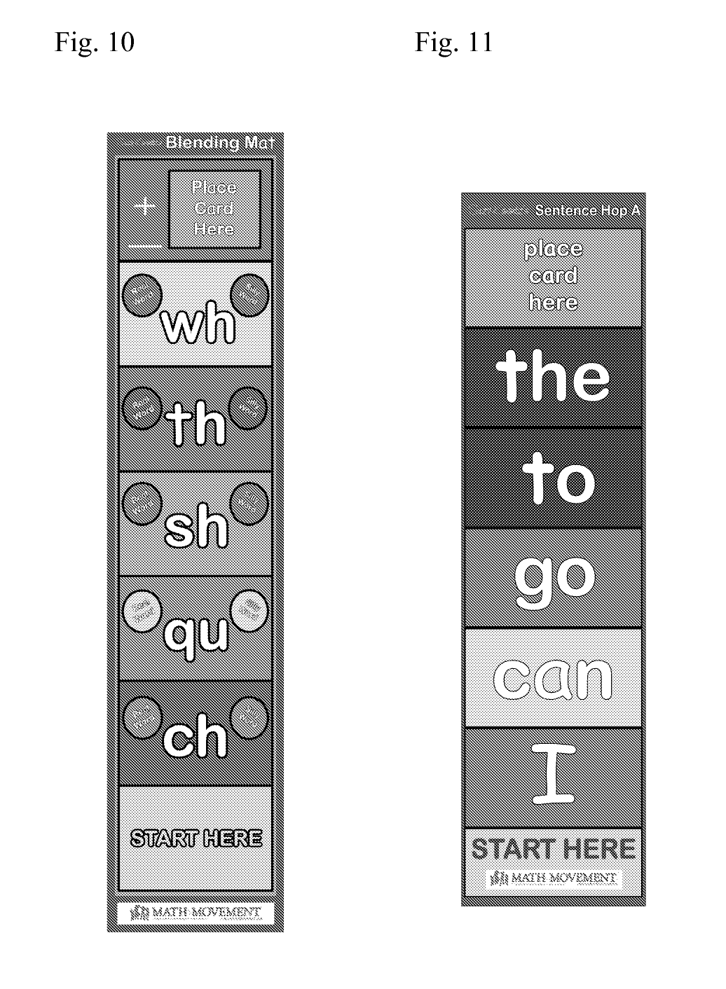

The display of FIG. 10 provides a kinesthetic opportunity for children to practice concepts, including, but not limited to, blending words. Children preferably physically hop from box to box as they blend words. In some embodiments, the display has a series of single letters in the boxes. In one embodiment, the letters are “b”, “c”, “d”, “f”, “g”, and “h”, although any series of single letters may be used. In another embodiment, the letters are “j”, “k”, “l”, “m”, “n”, and “p”. In another embodiment, the letters are “r, “s”, “t”, “w”, “y”, and “z”. In some embodiments, the display has a series of letter pairs in the boxes, such as the “ch”, “qu”, “sh”, “th”, and “wh” in the display of FIG. 10, although any series of double letters may be used within the spirit of the present invention. In another embodiment, the letters are “bl”, “cl”, “fl”, “gl”, “pl”, and “sl”. In another embodiment, the letters are “br”, “cr”, “dr”, “fr”, “gr”, “pr”, and “tr”. In another embodiment, the letters are “sc, “sk”, “sm”, “sn”, “sp”, and “st”.

In one embodiment, the student places a word-ending card at the top of the display in the box that says “place card here”. Word-ending cards preferably include at least a vowel followed by a consonant, such as “ar”, “ot”, “ain” and “one”. The student then stands on the “START HERE” box and says the letter sound in the first box above the “START HERE” box. The student says the root word at the top of the display and then hops on the first box while blending the initial sound with the root word to make a word. The teacher asks the student if she has created a real or silly word. If the student has created a real word, she crosses her right leg over her left leg and touches the “real word” circle. If the student has created a silly word, she crosses her left leg over her right leg and taps the “silly word” circle.

### Sentences

The display of FIG. 11 provides a kinesthetic opportunity for children to practice learning to read beginning sentences. Simple sentences are laid out in a format so that the student hops on each word on the display to form a complete sentence. A word card placed in the top box completes the sentence. Words appropriate for word cards used with the display of FIG. 11 are preferably locations, including, but are not limited to, “zoo”, “bank”, “park”, and “library”.

In one embodiment, the student chooses a word card from the pile of word cards and reads the word a predetermined number of times appropriate for the age of the child. The child then places the word card at the top of the display of FIG. 11 in the “place card here” box. The student stands on the “START HERE” box and hops on each word while simultaneously reading the word. A teacher preferably corrects the student if the student says the word incorrectly. The student preferably changes the word card at the top of the display and repeats the activity multiple times.

In some embodiments, word cards may be placed in more than one box to form a complete sentence. In some embodiments, the word card for a particular part of speech, including, but not limited to, a noun, a verb, a preposition, an adjective, or an adverb, is placed in a particular box to create a new sentence.

### Contractions

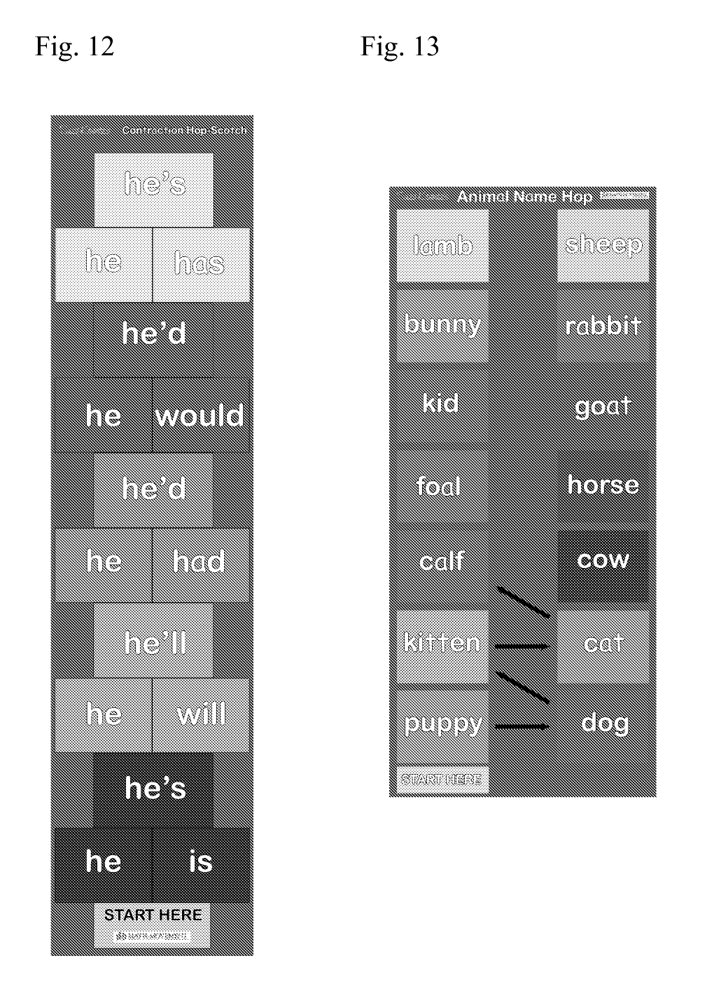

The display of FIG. 12 provides a kinesthetic opportunity for children to practice concepts, including, but not limited to, learning to read beginning and basic contractions. The display of FIG. 12 is arranged with the two words that contract arranged in boxes next to each other below the box with the simple contraction.

In one embodiment, the student hops on the words and contractions in sequence, alternating between one- and two-footed hops, preferably while speaking the words when landing in the boxes. The student begins by standing in the “START HERE” box and uses a two-footed hop to land on two words that contract and then hops on the contraction of the two words with one foot.

Using the display of FIG. 12, the student says and hops on the words “he” and “is” simultaneously, with her left foot on the word “he” and her right foot on the word “is”. Then the student hops with one foot on the contraction she is while saying “he's”. The student continues this sequence throughout the display.

In one embodiment, the method borrows from the traditional hop-scotch approach on a number display rather than a contraction display. The student says and hops on the numerals one and two simultaneously, with his left foot on the numeral one and his right foot on the numeral two. Then the student hops with one foot on the numeral three while saying “three”. The student continues this sequence throughout the display.

### Lateral Hopping

The display of FIG. 13 provides a kinesthetic opportunity for learning concepts, including, but not limited to, relationships between pairs. The pairs in the display of FIG. 13 are the baby animal and the adult animal. In one embodiment, the child hops laterally from left to right as indicated by the arrows on the display, while saying the word name in each box as they hop. The student hops to left box and says the left word, and then the student jumps laterally to the right box and says the right word. The student continues to the top of the display by following the sequence of arrows and next hopping laterally to the left box above the first left box and saying the left word.

Using the display of FIG. 13, the student hops on the word puppy and says “puppy”, then the student jumps laterally to the right onto the word dog and says “dog”. Next the student hops to the word kitten and says “kitten”. Then student hops to word cat and says the word “cat”. The student continues this pattern in a like manner to the top of the display.

### General Movement-Based Learning of a Concept

While the above embodiments show methods of teaching and learning for specific concepts, the methods may be applied to many different fields and concepts. The method preferably involves moving on a display, such as walking, hopping, jumping, or crawling, while simultaneously chanting or saying a corresponding word, letter, or sound associated with the movement on the display. In some embodiments, the students do matching exercises with the display, such as crawling on the display, tracing each indicium on the display with one or two fingers, or hopping on the display while simultaneously saying letters and then a word.

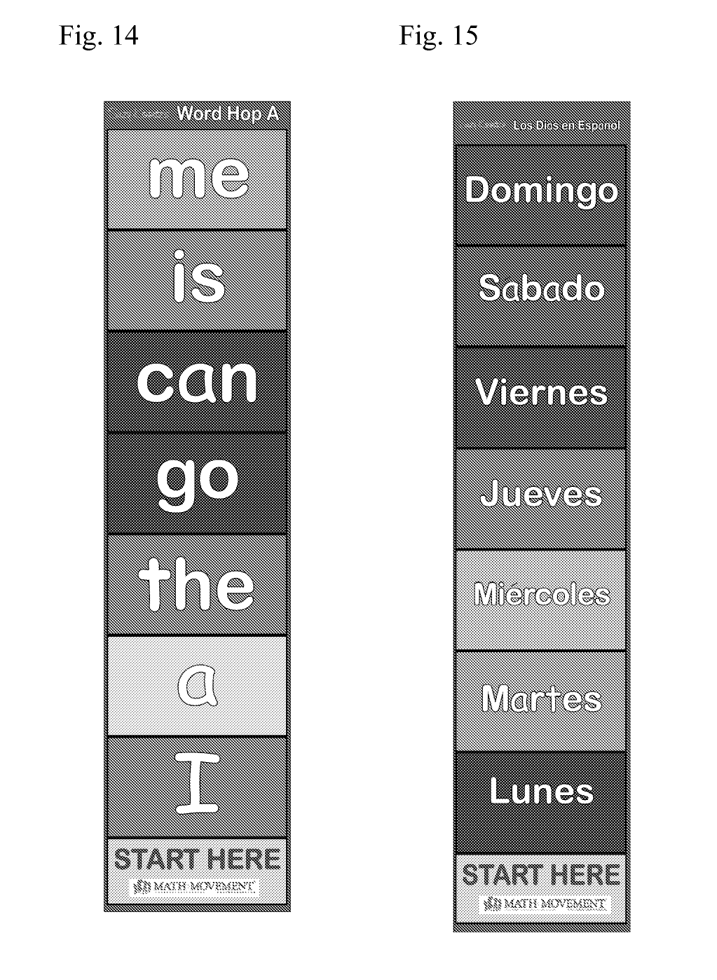

The display of FIG. 14 provides a kinesthetic opportunity for helping a child to learn sight words. Similar methods may be applied not only to the concepts mentioned above, but also to other concepts, including, but not limited to, learning the letters of the alphabet, words or alphabets in foreign languages, musical notes, names of animals, science terms, or numbers.

The display of FIG. 15 provides a kinesthetic opportunity for helping a child to learn words in a language other than English. The display of FIG. 15 includes seven boxes with the seven days of the week in Spanish. Alternatively, a foreign language display such as the one in FIG. 15 may include lateral hopping such as in the format of the display of FIG. 13 with the word in one language in one column and the word in another language in the second column.

### Make-A-Word

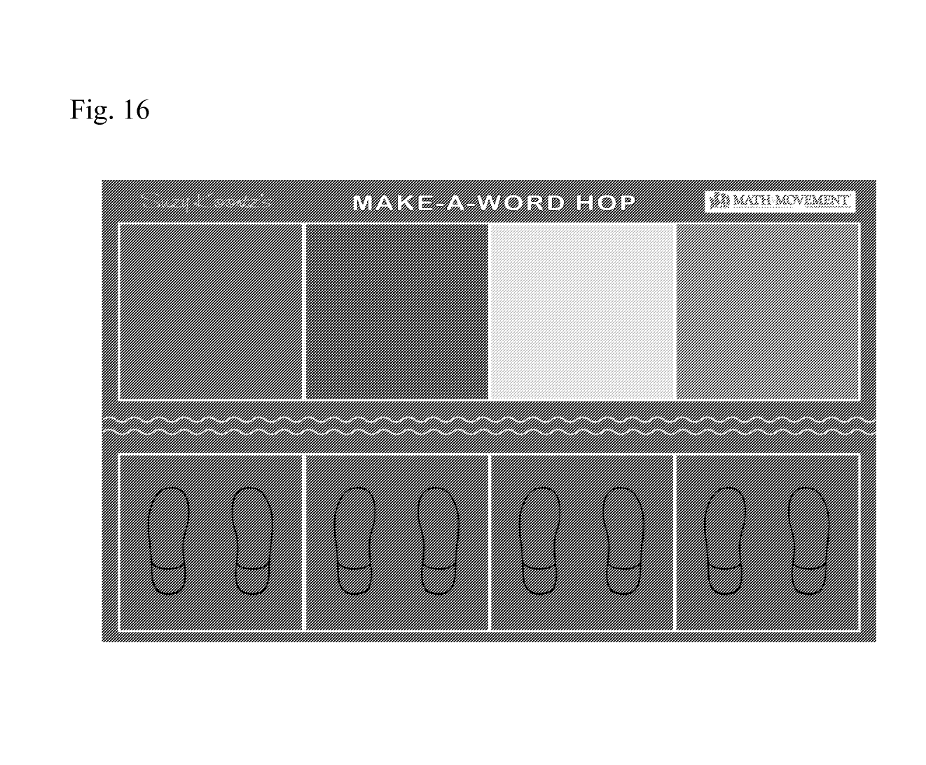

The display of FIG. 16 may be used in teaching methods, including, but not limited to, a phonics-based method of teaching reading to children. In one embodiment, words are created with letter and word cards placed in the upper row of boxes. The child stands on the display below the first letter. A sound or motion is made, such as a bell ringing or a hand motion, to initiate the beginning of the exercise. The child sounds out the letter until directed to move, such as by hopping, stepping, or jumping, to the box under the next letter, and the exercise is repeated until all of the letters or letter combinations are sounded out by the child. Next the child chants the entire word while hopping on the word or on the box below the word.

In one embodiment, if the word is “mat”, the student places the card “m” in the first box, the card “a” in the second box, the card “t” in the third box, and the word card “mat” in the fourth box. The student then stands on the box below the “m”. The teacher rings a bell. The student makes the sound for the letter “m” until the teacher rings the bell again. At this point, the student hops to the right to the box under the letter “a” and makes the sound for the letter “a”. Again the teacher rings the bell, and the student hops to right again and quickly says the sound of the letter “t”. The teacher rings the bell quickly, since the letter sound “t” cannot be hummed or drawn out. Next the student hops to the right and says the word “mat”. If the student has difficulty with the exercise, then he repeats the activity until he is successful. If the student completes the exercise with ease, then he changes the cards and repeats the activity with a new word.

Although the previously-described embodiments have been described with a live human teacher, in some embodiments, the teaching instructions are automatically provided to the student. The instructions may be provided in either visual or auditory or both visual and auditory form by any automated device, including, but not limited to, a computer, a toy, a global positioning system (GPS) device, a cellular telephone.

In one embodiment of the present invention, the student locates a display in a permanent form on the ground or on a floor and uses a GPS device to determine the student's location. The GPS device then provides the student with instructions associated with the specific display that the student has found. The student follows the instructions to learn one or more concepts associated with the specific display. The routine may be any routine as described herein and the concept may be any concept as described herein. The display may be located in any place in which a GPS device can acquire satellites to determine its position. In one embodiment, the display is located on the floor of a store and the method provides a child with an activity to do while a parent of the child shops at the store.

Although the terms “student” and “child” have been used somewhat interchangeably to refer to the learner, it is to be understood that an adult may be the learner in any of the above-described embodiments without deviating from the spirit of the present invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of teaching at least one concept comprising the steps of:
a) providing at least one display and a plurality of indicia on the display associated with the concept;
b) instructing at least one student to move in a predetermined sequence associated with the concept from indicium to indicium on the display; and
c) instructing the student to perform at least one action associated with the concept and associated with each indicium in coordination with moving in the predetermined sequence from indicium to indicium on the display.

2. The method of claim 1, wherein the action is selected from the group consisting of:
counting, speaking at least one sound associated with the indicium, making at least one body movement, and any combination of counting, speaking at least one sound associated with the indicium, and making at least one body movement.

3. The method of claim 1, wherein the indicia are symbols selected from the group consisting of: numerals, letters, words, images, and any combination of numerals, letters, words, and images.

4. The method of claim 1, wherein step b) comprises the substep of instructing the student to move in a manner selected from the group consisting of: stepping, walking, hopping, jumping, and any combination of these in a direction selected from the group consisting of: forward, backward, and laterally.

5. The method of claim 1, wherein the concept is a mathematical concept, the indicia comprise numerals, and the action is selected from the group consisting of: counting, speaking what the indicium represents, speaking at least one sound associated with the indicium, making at least one body movement, and any combination of counting, speaking what the indicium represents, speaking at least one sound associated with the indicium, and making at least one body movement.

6. The method of claim 5, wherein the concept is selected from the group consisting of: place value, multiples including skip counting, Cartesian coordinates, proper fractions, improper fractions, mixed numbers, manipulation of fractions, positive and negative numbers, unit circle, geometry, multiplication, division, addition, subtraction, factoring, measurement, rounding, estimation, clock, money, number patterns, decimals, percentages, number recognition, understanding the value of numbers, one-to-one correspondence, odd and even numbers, trigonometry, calculus, probability, and statistics.

7. The method of claim 1, wherein the concept is a linguistic concept, the indicia comprise letters, and the action is selected from the group consisting of: speaking what the indicium represents, speaking at least one sound associated with the indicium, making at least one body movement, and any combination of speaking what the indicium represents, speaking at least one sound associated with the indicium, and making at least one body movement.

8. The method of claim 7, wherein the concept is selected from the group consisting of: sound recognition, word recognition, reading sight words, reading color words, blending words, contractions, phonetic blending of short vowel words, transfer between spoken words and sentences to reading, words from foreign languages, and alphabets from foreign languages.

9. The method of claim 1, wherein the indicia are printed on cards, the method further comprising the step of instructing the student to place the cards on the display in a predetermined arrangement.

10. The method of claim 1, wherein steps b) and c) are provided by an automated device.

11. A method of learning at least one concept using at least one display and a plurality of indicia on the display associated with the concept, the method comprising the steps of:
a) moving in a predetermined sequence associated with the concept from indicium to indicium on the display; and
b) performing at least one action associated with the concept and associated with each indicium in coordination with moving in the predetermined sequence from indicium to indicium on the display.

12. The method of claim 11, wherein the action is selected from the group consisting of: counting, speaking at least one sound associated with the indicium, making at least one body movement, and any combination of counting, speaking at least one sound associated with the indicium, and making at least one body movement.

13. The method of claim 11, wherein the indicia are symbols selected from the group consisting of: numerals, letters, words, images, and any combination of numerals, letters, words, and images.

14. The method of claim 11, wherein step a) comprises the substep of moving in a manner selected from the group consisting of: stepping, walking, hopping, jumping, and any combination of these in a direction selected from the group consisting of: forward, backward, and laterally.

15. The method of claim 11, wherein the concept is a mathematical concept, the indicia comprise numerals, and the action is selected from the group consisting of: counting, speaking what the indicium represents, speaking at least one sound associated with the indicium, making at least one body movement, and any combination of counting, speaking what the indicium represents, speaking at least one sound associated with the indicium, and making at least one body movement.

16. The method of claim 15, wherein the concept is selected from the group consisting of: place value, multiples including skip counting, Cartesian coordinates, proper fractions, improper fractions, mixed numbers, manipulation of fractions, positive and negative numbers, unit circle, geometry, multiplication, division, addition, subtraction, factoring, measurement, rounding, estimation, clock, money, number patterns, decimals, percentages, number recognition, understanding the value of numbers, one-to-one correspondence, odd and even numbers, trigonometry, calculus, probability, and statistics.

17. The method of claim 11, wherein the concept is a linguistic concept, the indicia comprise letters, and the action is selected from the group consisting of: speaking what the indicium represents, speaking at least one sound associated with the indicium, making at least one body movement, and any combination of speaking what the indicium represents, speaking at least one sound associated with the indicium, and making at least one body movement.

18. The method of claim 17, wherein the concept is selected from the group consisting of: sound recognition, word recognition, reading sight words, reading color words, blending words, contractions, phonetic blending of short vowel words, transfer between spoken words and sentences to reading, words from foreign languages, and alphabets from foreign languages.

19. The method of claim 11, wherein the indicia are printed on cards, the method further comprising the step of placing the cards on the display in a predetermined arrangement.

20. The method of claim 11 further comprising the steps of:
c) finding the display at a permanent location;
d) using a GPS device to determine the permanent location; and
e) following instructions from the GPS device for moving in the predetermined sequence and performing the action.

21. A method of teaching at least one concept comprising the steps of:
a) providing at least one wall mat and a plurality of indicia on the wall mat associated with the concept;
b) instructing at least one student to move in a predetermined sequence associated with the concept while looking at an indicium associated with the concept on the wall mat; and
c) instructing the student to perform at least one action associated with the concept and associated with each indicium in coordination with moving in the predetermined sequence associated with the concept.

22. The method of claim 21, wherein the concept is a mathematical concept, the indicia comprise numerals, and the action is selected from the group consisting of: counting, speaking what the indicium represents, speaking at least one sound associated with the indicium, making at least one body movement, and any combination of counting, speaking what the indicium represents, speaking at least one sound associated with the indicium, and making at least one body movement.
